(19) United States
(12) Patent Application Publication
(10) Pub. No.: US 2018/0157969 A1
(43) Pub. Date: Jun. 7, 2018

(54) Apparatus and Method for Achieving Accelerator of Sparse Convolutional Neural Network

(71) Applicant: BEIJING DEEPHI TECHNOLOGY CO., LTD., Beijing (CN)

(72) Inventors: Dongliang XIE, Beijing (CN); Yu ZHANG, Beijing (CN); Yi SHAN, Beijing (CN)

(21) Appl. No.: 15/831,762

(22) Filed: Dec. 5, 2017

(30) Foreign Application Priority Data
Dec. 5, 2016 (CN) 201611104030.2

(51) Int. Cl. G06N 3/063; G06F 7/57; G06F 7/544

(52) U.S. Cl. CPC G06N 3/063; G06F 7/5443; G06F 7/57

(57) ABSTRACT

An apparatus for achieving an accelerator of a sparse convolutional neural network is provided. The apparatus comprises a convolution and pooling unit, a full connection unit and a control unit. Convolution parameter information and input data and intermediate calculation data are read based on control information, and weight matrix position information of a full connection layer is also read. Then a convolution and pooling operation for a first iteration number of times is performed on the input data in accordance with the convolution parameter information, and then a full connection calculation for a second iteration number of times is performed in accordance with the weight matrix position information of the full connection layer. Each input data is divided into a plurality of sub-blocks, and the convolution and pooling unit and the full connection unit perform operations on the plurality of sub-blocks in parallel, respectively.

### TECHNICAL FIELD

The present disclosure relates to an artificial neural network, and in particular to apparatus and method for achieving an accelerator of a sparse convolutional neural network.

### BACKGROUND ART

An artificial neural network (ANN) is also called a neural network (NN) for short, and is an algorithm mathematical model that imitates behavioral characteristics of an animal neural network, and performs a distributed parallel information processing. In recent years, the neural network has developed rapidly, and has been widely used in many fields, including image recognition, speech recognition, natural language processing, weather forecasting, gene expression, content pushing and so on.

FIG. 1 illustrates a calculation principle diagram of one neuron in an artificial neural network.

A stimulation of an accumulation of neurons is a sum of stimulus quantities delivered by other neurons with corresponding weights, Xj is used to express such accumulation at the jth neuron, yi is used to express the stimulus quantity delivered by the ith neuron, and Wi is used to express the weight that links the stimulation of the ith neuron. A formula can be obtained below:

Xj=(y1*W1)+(y2*W2)+ . . . +(yi*Wi)+ . . . +(yn*Wn).

After the Xj completes the accumulation, the jth neuron that completes the accumulation itself propagates stimulations to some surrounding neurons, which is expressed as yj, shown as follows:

yj=f(Xj).

After the jth neuron is processed in accordance with the result of the Xj after the accumulation, the stimulation yj is delivered externally. An function f(⋅) is used to express such processing, and is called an activation function.

A convolutional neural network (CNN) is a kind of the artificial neural network, and has become a current hot topic in the fields of speech analysis and image recognition. A weight sharing network structure thereof makes it more similar to a biological neural network, reduces complexity of a network model, and reduces the number of weights. This advantage is more obvious when an input of the network is a multidimensional image, enables the image to directly serve as the input of the network, and avoids a complicated process of feature extraction and data reconstruction in a traditional recognition algorithm. The convolutional network is a multilayer preceptor specially designed for recognition of two-dimensional shapes, and such network structure is highly invariant with respect to offset, scaling, tilting, or other forms of deformations.

FIG. 2 shows a schematic diagram of a processing structure of a convolutional neural network.

The convolutional neural network is a multilayer neural network, each layer is composed of multiple two-dimensional planes, and each plane is composed of multiple independent neurons. The convolutional neural network is generally composed of a convolution layer, a down-sampling layer (or called a pooling layer) and a full connection (FC) layer.

The convolutional layer produces a feature map of input data through a linear convolution kernel and a nonlinear activation function, the convolution kernel is repeatedly subjected to an inner product with different regions of the input data, and is then output through the nonlinear function, and the nonlinear function is generally rectifier(⋅), sigmoid(⋅), tanh(⋅) and so on. By taking rectifier(⋅) as an example, the calculation of the convolutional layer can be expressed as follows:

f_{i,j,k}=max(wₖ^{T}x_{i,j},0),

where (i,j) is a pixel index in the feature map, x_{i,j} expresses that an input domain takes (i,j) as a center, and k expresses a channel index of the feature map. Although the convolution kernel is subjected to the inner product with the different regions of the input image in the calculation process of the feature map, the convolution kernel is not changed.

The pooling layer is generally a layer of average pooling or maximal pooling, and this layer only calculates or finds an average or maximum value of a region in the feature map on the previous layer.

The full connection layer is similar to a traditional neural network, all elements at an input end are connected to the output neurons, and each output element is obtained by multiplying all input elements by their respective weights and then performing a summation.

In recent years, the scale of the neural network has been growing, published comparatively advanced neural networks all have hundreds of millions of links, which is applied to a calculation and memory access intensive application, and is generally achieved by adopting a general-purpose processor (e.g., CPU) or a graphics processor (GPU) in an existing technical solution, and along with a gradual approach of a transistor circuit to a limit, the Moore's law will come to an end.

In a case where the neural network gradually gets large, a model compression becomes extremely important. The model compression can transform a dense neural network into a sparse neural network, which can effectively reduce an amount of calculation and reduce an amount of memory access. But the CPU and the GPU cannot sufficiently enjoy benefits brought by sparseness, and acceleration achieved is extremely limited. A traditional sparse matrix calculation architecture cannot be fully adapted to the calculation of the neural network. Experiments that have been published show that a speedup ratio of the existing processor is limited when a model compression rate is comparatively low. Thus, a special-purpose custom circuit can solve the problem above, and can make the processor obtain a better speedup ratio at a comparatively low compression rate.

As for the convolutional neural network, since the convolution kernel of the convolution layer can share parameters, a quantity of parameters of the convolution layer is relatively small, and the convolution kernel is generally comparatively small (1*1, 3*3, 5*5 and so on), so a sparseness effect of the convolution layer is not obvious. The amount of calculation of the polling layer is also comparatively small. But the full connection layer still has a large number of parameters, and the amount of calculation will be greatly reduced if a sparseness processing is performed on the full connection layer.

Thus, it is desired to put forward an apparatus and a method for achieving an accelerator of a sparse CNN to achieve an object of improving a calculation performance and reducing a response delay.

### SUMMARY OF THE INVENTION

Based on discussions above, the present disclosure puts forward a dedicated circuit, supports a sparse CNN network of an FC layer, adopts a ping-pang buffer parallelization design, and effectively balances an I/O bandwidth and a calculation efficiency.

In the exiting technical solution, a dense CNN network needs a comparatively large I/O bandwidth, and a comparatively large number of storage and calculation resources. In order to adapt to algorithm requirements, a model compression technique becomes more and more popular. The sparse neural network after the model compression needs to be encoded for storage and needs to be decoded for calculation. The present disclosure adopts a custom circuit and a pipeline design, and can obtain a comparatively good performance per watt.

An objective of the invention lies in providing an apparatus and a method for achieving an accelerator of a sparse CNN network to achieve an objective of improving a calculation performance and reducing a response delay.

According to a first aspect of the present invention, an apparatus for achieving an accelerator of a sparse convolutional neural network is provided. The apparatus may comprise: a convolution and pooling unit for performing a convolution and pooling operation for a first iteration number of times on input data in accordance with convolution parameter information to finally obtain an input vector of a sparse neural network, wherein each input data is divided into a plurality of sub-blocks, and the convolution and pooling unit performs the convolution and pooling operation on the plurality of sub-blocks in parallel; a full connection unit for performing a full connection calculation for a second iteration number of times on the input vector in accordance with weight matrix position information of a full connection layer to finally obtain a calculation result of the sparse convolutional neural network, wherein each input vector is divided into a plurality of sub-blocks, and the full connection unit performs a full connection operation on the plurality of sub-blocks in parallel; and a control unit for determining and sending the convolution parameter information and the weight matrix position information of the full connection layer to the convolution and pooling unit and the full connection unit respectively, and controlling reading of the input vectors on respective iterative levels in the units above and their state machines.

In the apparatus for achieving an accelerator of a sparse convolutional neural network according to the present invention, the convolution and pooling unit may further comprise: a convolution unit for performing a multiplication operation of the input data and the convolution parameter; an adder tree unit for accumulating output results of the convolution unit to complete a convolution operation; a nonlinear unit for performing a nonlinear processing on a convolution operation result; and a pooling unit for performing a pooling operation on the operation result after the nonlinear processing to obtain the input data on the next iterative level or finally obtain the input vector of the sparse neural network.

Preferably, the adder tree unit further adds a bias in accordance with the convolution parameter information in addition to accumulating the output result of the convolution unit.

In the apparatus for achieving an accelerator of a sparse convolutional neural network according to the invention, the full connection unit may further comprise: an input vector buffer unit for buffering the input vector of the sparse neural network; a pointer information buffer unit for buffering compressed pointer information of the sparse neural network in accordance with the weight matrix position information of the full connection layer; a weight information buffer unit for buffering compressed weight information of the sparse neural network in accordance with the compressed pointer information of the sparse neural network; an arithmetic logic unit (ALU) for performing a multiplication-accumulation calculation in accordance with the compressed weight information and the input vector of the sparse neural network; an output buffer unit for buffering an intermediate calculation result and a final calculation result of the ALU; and an activation function unit for performing an activation function operation on the final calculation result in the output buffer unit to obtain the calculation result of the sparse convolutional neural network.

Preferably, the compressed weight information of the sparse neural network may comprise a position index value and a weight value. The ALU may be further configured to: perform a multiplication operation of the weight value and a corresponding element of the input vector; read data in a corresponding position in the output buffer unit in accordance with the position index value, and add the data to the result of the multiplication operation above; and write the result of the addition into the corresponding position in the output buffer unit in accordance with the position index value.

According to s second aspect of the present invention, a method for achieving an accelerator of a sparse convolutional neural network is provided. The method may comprises: reading convolution parameter information and input data and intermediate calculation data based on control information, and reading weight matrix position information of a full connection layer; performing a convolution and pooling operation for a first iteration number of times on the input data in accordance with the convolution parameter information to finally obtain an input vector of a sparse neural network, wherein each input data is divided into a plurality of sub-blocks, and the convolution and pooling operation is performed on the plurality of sub-blocks in parallel; and performing a full connection calculation for a second iteration number of times on the input vector in accordance with the weight matrix position information of the full connection layer to finally obtain a calculation result of the sparse convolutional neural network, wherein each input vector is divided into a plurality of sub-blocks, and a full connection operation is performed in parallel.

In the method for achieving an accelerator of a sparse convolutional neural network according to the present invention, the step of performing a convolution and pooling operation may further comprise: performing a multiplication operation of the input data and the convolution parameter; accumulating output results of the multiplication operation to complete a convolution operation; performing a nonlinear processing on a convolution operation result; and performing a pooling operation on the operation result after the nonlinear processing to obtain the input data on the next iterative level or finally obtain the input vector of the sparse neural network.

Preferably, the step of accumulating output results of the multiplication operation to complete a convolution operation may further comprise: adding a bias in accordance with the convolution parameter information.

In the method for achieving an accelerator of a sparse convolutional neural network according to the present invention, the step of performing a full connection calculation may further comprise: buffering the input vector of the sparse neural network; buffering compressed pointer information of the sparse neural network in accordance with the weight matrix position information of the full connection layer; buffering compressed weight information of the sparse neural network in accordance with the compressed pointer information of the sparse neural network; performing a multiplication-accumulation calculation in accordance with the compressed weight information and the input vector of the sparse neural network; buffering an intermediate calculation result and a final calculation result of the multiplication-accumulation calculation; and performing an activation function operation on the final calculation result of the multiplication-accumulation calculation to obtain the calculation result of the sparse convolutional neural network.

Preferably, the compressed weight information of the sparse neural network comprises a position index value and a weight value. The step of performing a multiplication-accumulation calculation in accordance with the compressed weight information and the input vector of the sparse neural network may further comprise: performing a multiplication operation of the weight value and a corresponding element of the input vector, reading data in a corresponding position in the buffered intermediate calculation result in accordance with the position index value, and adding the data to the result of the multiplication operation above, and writing the result of the addition into the corresponding position in the buffered intermediate calculation result in accordance with the position index value.

The objective of the present invention is to adopt a high concurrency design and efficiently process the sparse neural network to thereby obtain a better calculation efficiency and a lower processing delay.

### BRIEF DESCRIPTION OF THE DRAWINGS

The present disclosure is described below with reference to figures in combination with embodiments. In the figures:

FIG. 1 illustrates a calculation principle diagram of one neuron in an artificial neural network;

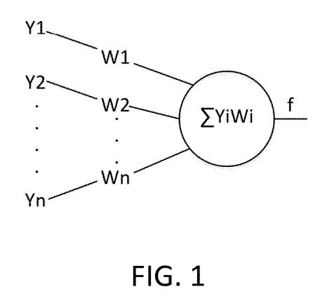

FIG. 2 shows a schematic diagram of a processing structure of a convolutional neural network;

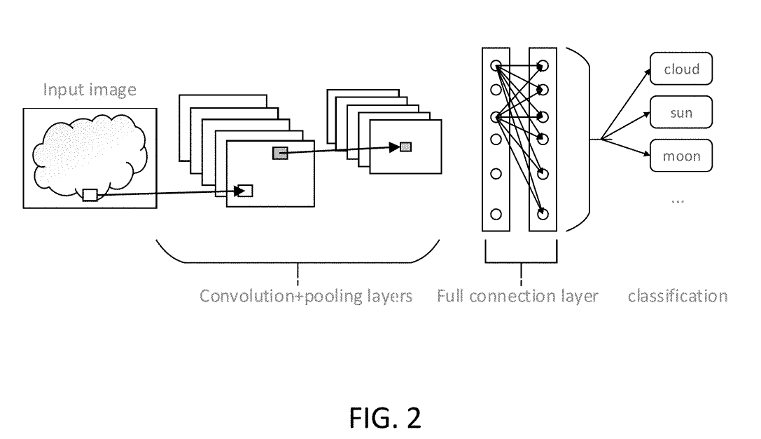

FIG. 3 is a schematic diagram of an apparatus for achieving an accelerator of a sparse convolutional neural network according to the present invention;

FIG. 4 is a schematic diagram of a specific structure of a convolution and pooling unit according to the present invention;

FIG. 5 is a schematic diagram of a specific structure of a full connection unit according to the present invention;

FIG. 6 is a flow chart of a method for achieving an accelerator of a sparse convolutional neural network according to the present invention;

FIG. 7 is a schematic diagram of a calculation layer structure of Specific Implementation Example 1 of the present invention;

FIG. 8 is a schematic diagram illustrating a multiplication operation of a sparse matrix and a vector according to Specific Implementation Example 2 of the present invention; and

FIG. 9 is a schematic table illustrating weight information corresponding to PE0 according to Specific Implementation Example 2 of the present invention.

### DETAILED DESCRIPTION OF THE EMBODIMENTS

Specific embodiments of the present disclosure will be explained in detail below by taking the figures into consideration.

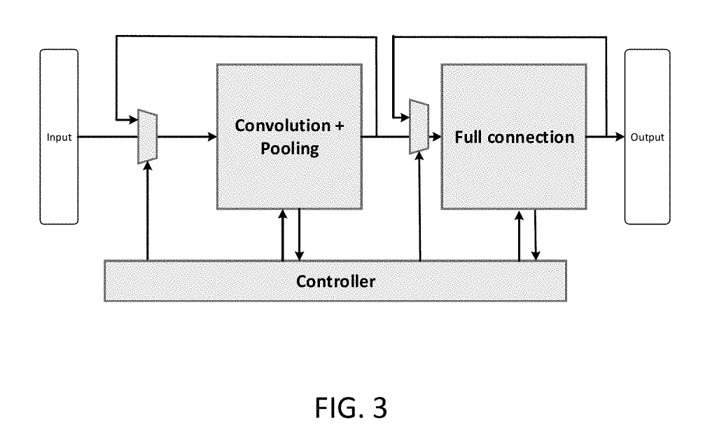

FIG. 3 is a schematic diagram of an apparatus for achieving an accelerator of a sparse convolutional neural network according to the present invention.

The present disclosure provides an apparatus for achieving an accelerator of a sparse convolutional neural network. As shown in FIG. 3, the apparatus mainly comprises the following three modules: a convolution and pooling unit, a full connection unit, and a control unit. To be specific, the convolution and pooling unit, which can be also called a Convolution+Pooling module, is used for performing a convolution and pooling operation for a first iteration number of times on input data in accordance with convolution parameter information to finally obtain an input vector of a sparse neural network, wherein each input data is divided into a plurality of sub-blocks, and the convolution and pooling unit performs the convolution and pooling operation on the plurality of sub-blocks in parallel. The full connection unit, which can be also called a Full Connection module, is used for performing a full connection calculation for a second iteration number of times on the input vector in accordance with weight matrix position information of a full connection layer to finally obtain a calculation result of the sparse convolutional neural network, wherein each input vector is divided into a plurality of sub-blocks, and the full connection unit performs a full connection operation on the plurality of sub-blocks in parallel. The control unit, which can be also called a Controller module, is used for determining and sending the convolution parameter information and the weight matrix position information of the full connection layer to the convolution and pooling unit and the full connection unit respectively, and controlling reading of the input vectors on respective iterative levels in the units above and their state machines.

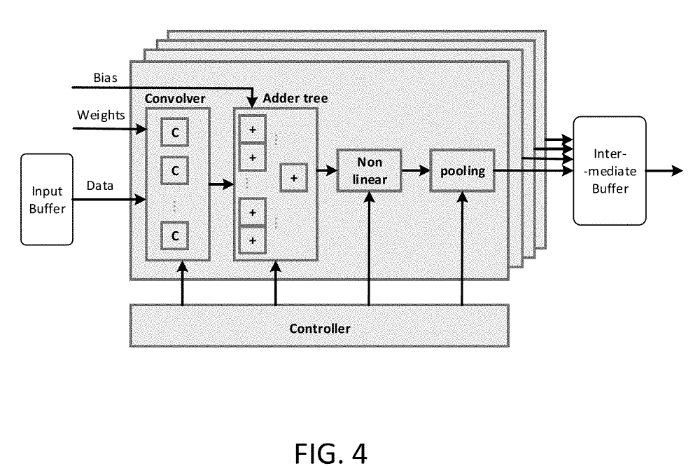

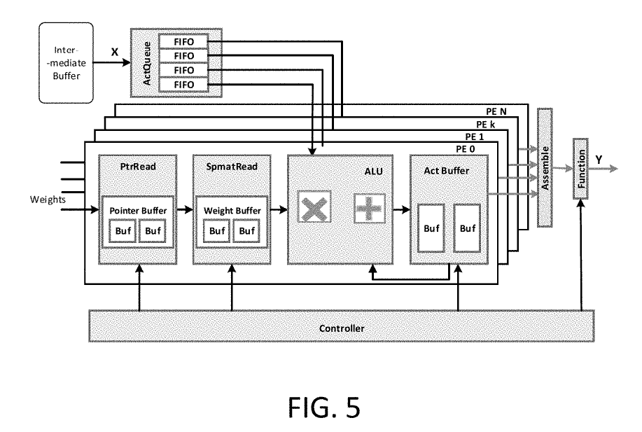

The respective units will be further described in detail below by taking FIGS. 4 and 5 into consideration.

FIG. 4 is a schematic diagram of a specific structure of a convolution and pooling unit according to the present invention.

The convolution and pooling unit of the invention is used for achieving calculations of a convolution layer and a pooling layer in CNN, and the unit can be instantiated as multiple ones to achieve parallel calculations, i.e., each input data is divided into a plurality of sub-blocks, and the convolution and pooling unit performs the convolution and pooling operation on the plurality of sub-blocks in parallel.

It should be noted that the convolution and pooling unit not only performs a partitioning parallel processing on the input data, but also performs an iterative processing on several levels on the input data. As for the specific number of iterative levels, those skilled in the art can specify different numbers in accordance with specific applications. For example, with respect to processed objects of different types, e.g., video or speech, the number of the iterative levels may be required to be differently specified.

As shown in FIG. 4, the unit includes, but is not limited to, the following units (also called modules):

A convolution unit, which can be also called a Convolver module, is used for achieving a multiplication operation of the input data and a convolution kernel parameter.

An adder tree unit, which can be also called an Adder Tree module, is used for accumulating output results of the convolution unit to complete a convolution operation, and further adding a bias in a case that there is an input of the bias.

A nonlinear unit, which can be also called a Nonlinear module, is used for achieving a nonlinear activation function that may be rectifier(⋅), sigmoid(⋅), tanh(⋅) or others according to requirements.

A pooling unit, which can be also called a Pooling module, is used for performing a pooling operation on the operation result after the nonlinear processing to obtain the input data on the next iterative level or finally obtain the input vector of the sparse neural network. The pooling operation herein may be a maximum pooling or an average pooling according to requirements.

FIG. 5 is a schematic diagram of a specific structure of a full connection unit according to the present invention.

The full connection unit of the present invention is used for achieving a calculation of a sparse full connection layer. Similar to the convolution and pooling unit, it should be noted that the full connection unit not only performs a partitioning parallel processing on the input vector, but also performs an iterative processing on several levels on the input vector. As for the specific number of iterative levels, those skilled in the art can specify different numbers in accordance with specific applications. For example, with respect to processed objects of different types, e.g., video or speech, the number of the iterative levels may be required to be differently specified. In addition, the number of the iterative levels of the full connection unit can be the same as or different from the number of iterative levels of a convolution and pooling layer, which depends on specific applications and different control requirements for the calculation result by those skilled in the art.

As shown in FIG. 5, the unit includes, but is not limited to, the following units (also called modules or sub-modules):

An input vector buffer unit, which can be also called an ActQueue module, is used for storing the input vector of the sparse neural network. A plurality of calculation units (Process Elements, PEs) may share the input vector. The module contains a first input first output (FIFO) buffer, each calculation unit PE corresponds to one FIFO, and a difference in terms of an amount of calculation between the plurality of calculation units can be efficiently balanced under a same input element. Setting of the depth of the FIFO can take an empirical value. A too large depth will waste resources, and a too small depth cannot efficiently balance a calculation difference between different PEs.

A pointer information buffer unit, which can be also called a PtrRead module, is used for buffering compressed pointer information of the sparse neural network in accordance with the weight matrix position information of the full connection layer. If a sparse matrix adopts a storage format of a column storage (CCS), the PtrRead module stores a column pointer vector, and a Pⱼ₋₁-Pⱼ value in the vector expresses the number of nonzero elements in the jth column. There are two buffers in the design, and a ping-pang design is adopted.

A weight information buffer unit, which can be also called a SpmatRead module, is used for buffering compressed weight information of the sparse neural network in accordance with the compressed pointer information of the sparse neural network. The weight information stated herein includes a position index value, a weight value and so on. By means of Pⱼ₊₁ and Pⱼ values output by the PtrRead module, the weight value corresponding to the module can be obtained. The buffer of the module also adopts a ping-pang design.

An arithmetic logic unit (ALU), i.e., an ALU module, is used for performing a multiplication-accumulation calculation in accordance with the compressed weight information and the input vector of the sparse neural network. To be specific, in accordance with the position index and weight value sent by the SpmatRead module, three steps of calculation are mainly made as follows: first step, reading the input vector and weight of the neuron to perform a corresponding multiplication calculation; second step, reading a history accumulation result in a corresponding position in the next unit (ActBuffer module, or output buffer unit) in accordance with the index value, and further performing an addition operation with the result in the first step; third step, further writing the result of the addition into a corresponding position in the output buffer unit in accordance with the position index value. In order to improve a degree of concurrency, the module adopts multiple multiplication and adder trees to complete a multiplication-accumulation operation of the nonzero elements in one column.

An output buffer unit, which is also called an ActBuffer module, is used for buffering an intermediate calculation result and a final calculation result of a matrix operation of the ALU. In order to improve the calculation efficiency on the next level, the storage also adopts a ping-pang design and a pipeline operation.

An activation function unit, which is also called a Function module, is used for performing an activation function operation on the final calculation result in the output buffer unit. Conventional activation functions are, for example, sigmoid(⋅)/tanh(⋅)/rectifier(⋅). When an adder tree module completes an accumulation operation of respective groups of weights and vectors, the calculation result of the sparse convolutional neural network can be obtained via this function.

The control unit of the invention is responsible for a global control, a data input selection amount of the convolution and pooling layer, reading of the convolution parameter and input data, reading of the sparse matrix and input vector in the full connection layer, a control of a state machine in the calculation process and so on.

In accordance with reference descriptions above and with reference to illustrations of FIG. 3 to FIG. 5, the invention further provides a method for achieving an accelerator of a sparse CNN network, and includes the following specific steps:

Step 1: Initially, a parameter and input data of a convolution layer of CNN are read based on the global control information, and position information of a weight matrix of a full connection layer is read.

Step 2: The Convolver module performs a multiplication operation of the input data and the parameter, and a plurality of Convolver modules can calculate at the same time to achieve parallelization.

Step 3: The AdderTree module adds the result in the previous step and performs a summation with a bias in a case that there is the bias.

Step 4: The Nonlinear module performs a nonlinear processing on the result in the previous step.

Step 5: The Pooling module performs a pooling processing on the result in the previous step.

In the forgoing. Steps 2, 3, 4 and 5 are performed in a pipeline to improve the efficiency.

Step 6: Steps 2, 3, 4 and 5 are repeatedly performed in accordance with the number of iterative levels of the convolution layer (performed for the number of times). In the meanwhile, the Controller module makes a control to connect the result of the previous convolution and pooling to an input end of the convolution layer till the calculations of all of the layers are completed.

Step 7: A position index and a weight value of the sparse neural network are read in accordance with the weight matrix position information in Step 1.

Step 8: An input vector is broadcast to the plurality of calculation units PE in accordance with the global control information.

Step 9: The calculation unit makes a multiplication calculation of the weight value sent by the SpmatRead module and the corresponding element of the input vector sent by the ActQueue module.

Step 10: A calculation module reads data in a corresponding position in the output buffer ActBuffer module in accordance with the position index value in Step 7, and then makes an addition calculation with the multiplication result in Step 9.

Step 11: The addition result in Step 10 is written in the output buffer ActBuffer module in accordance with the index value in Step 7.

Step 12: A control module reads the result output in Step 11, which result passes through the activation function module to obtain a calculation result of a CNN FC layer.

Steps 7-12 can be also repeatedly performed in accordance with the specified number of iterative levels to thereby obtain a final calculation result of the sparse CNN.

Steps 1-12 above can be summarized as a method flow chart.

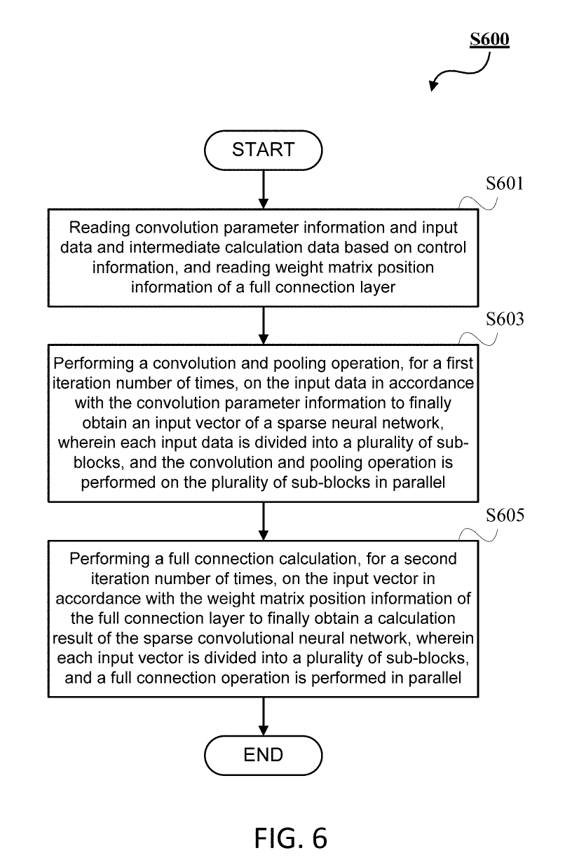

FIG. 6 is a flow chart of a method for achieving an accelerator of a sparse convolutional neural network according to the present invention.

The method S600 shown in FIG. 6 starts from Step S601. In this step, convolution parameter information and input data and intermediate calculation data are read based on control information, and weight matrix position information of a full connection layer is also read. This step corresponds to the operation of the control unit in the apparatus according to the present invention.

Next, in Step S603, a convolution and pooling operation for a first iteration number of times is performed on the input data in accordance with the convolution parameter information to finally obtain an input vector of a sparse neural network, wherein each input data is divided into a plurality of sub-blocks, and the convolution and pooling operation is performed on the plurality of sub-blocks in parallel. This step corresponds to the operation of the convolution and pooling unit in the apparatus according to the present invention.

To be more specific, the operation in Step S603 further comprises:
1. performing a multiplication operation of the input data and the convolution parameter, which corresponds to the operation of the convolution unit;
2. accumulating output results of the multiplication operation to complete a convolution operation, which corresponds to the operation of the adder tree unit; herein, if the convolution parameter information points out an existence of a bias, it being further required to add the bias;
3. performing a nonlinear processing on a convolution operation result, which corresponds to the operation of the nonlinear unit; and 4. performing a pooling operation on the operation result after the nonlinear processing to obtain the input data on the next iterative level or finally obtain the input vector of the sparse neural network, which corresponds to the operation of the pooling unit.

Next, in Step S605, a full connection calculation for a second iteration number of times is performed on the input vector in accordance with weight matrix position information of a full connection layer to finally obtain a calculation result of the sparse convolutional neural network, wherein each input vector is divided into a plurality of sub-blocks, and a full connection operation is performed in parallel. This step corresponds to the operation of the full connection unit in the apparatus according to the present invention.

To be more specific, the operation in Step S605 further comprises:
1. buffering the input vector of the sparse neural network, which corresponds to the operation of the input vector buffer unit;
2. buffering compressed pointer information of the sparse neural network in accordance with the weight matrix position information of the full connection layer, which corresponds to the operation of the pointer information buffer unit;
3. buffering compressed weight information of the sparse neural network in accordance with the compressed pointer information of the sparse neural network, which corresponds to the operation of the weight information buffer unit;
4. performing a multiplication-accumulation calculation in accordance with the compressed weight information and the input vector of the sparse neural network, which corresponds to the operation of the arithmetic logic unit;
5. buffering an intermediate calculation result and a final calculation result of the multiplication-accumulation calculation, which corresponds to the operation of the output buffer unit; and
6. performing an activation function operation on the final calculation result of the multiplication-accumulation calculation to obtain the calculation result of the sparse convolutional neural network, which corresponds to the operation of the activation function unit.

In Step S605, the compressed weight information of the sparse neural network comprises a position index value and a weight value. Thus, Sub-step 4 therein further comprises:
4.1 performing a multiplication operation of the weight value and a corresponding element of the input vector,
4.2 reading data in a corresponding position in the buffered intermediate calculation result in accordance with the position index value, and adding the data to the result of the multiplication operation above, and
4.3 writing the result of the addition into the corresponding position in the buffered intermediate calculation result in accordance with the position index value.

After Step S605 is completed, the calculation result of the sparse convolutional neural network is obtained. Thus, the method S600 ends.

A non-patent document, Song Han et al., EIE: Efficient Inference Engine on Compressed Deep Neural Network, ISCA 2016: 243-254, puts forward an EIE achieved by accelerator hardware, which is aimed at using characteristics that information redundancy of the CNN is comparatively high to enable neural network parameters obtained after compression to be completely allocated to SRAM, thereby greatly reducing access times of the DRAM, which can achieve a very good performance and performance per watt. As compared with a neural network accelerator DaDianNao that is not compressed, the throughput of the EIE is increased by 2.9 times, the performance per watt is increased by 19 times, and the area is only ⅓ of that of the DaDianNao. Herein, the content of this non-patent document as a whole is incorporated into the Description of the present disclosure by reference.

The apparatus and method for achieving the accelerator of the sparse CNN as proposed by the present invention and those in the EIE paper differ in that: in the design of the EIE, there is one calculation unit, and thus only one multiplication-accumulation calculation can be achieved in one cycle, but modules before and after one calculation kernel need a comparatively large number of storage and logic units. Either an application specific integrated circuit (ASIC) or a programmable chip will bring a relative unbalance of resources. In the achieving process, there is a comparatively high degree of concurrency, a relatively large number of on-chip storages and logical resources are desired, and DSP calculation resources desired in the chip are more unbalanced with the above two parts. The calculation unit of the invention adopts a high concurrency design, which does not make other logical circuits be correspondingly increased while increasing the DSP resources, and achieves objects of balancing a relationship among the calculations, the on-chip storages and the logical resources and so on.

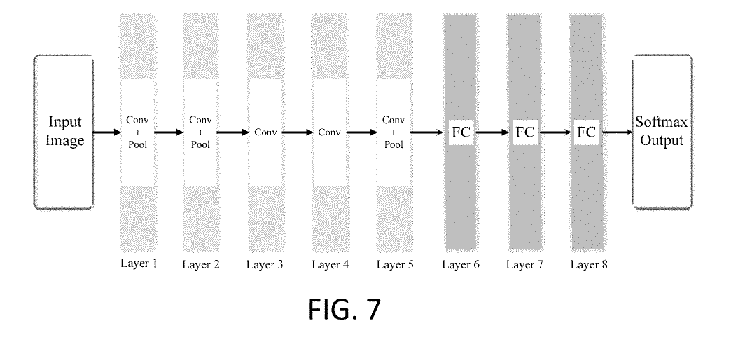

The two specific implementation examples of the invention are given by taking FIG. 7 to FIG. 9 into consideration.

### SPECIFIC IMPLEMENTATION EXAMPLE 1

FIG. 7 is a schematic diagram of a calculation layer structure of Specific Implementation Example 1 of the present invention.

As shown in FIG. 7, AlexNet is taken as an example, the network includes eight layers, i.e., five convolution layers and three full connection layers, in addition to an input and output. The first layer is convolution+pooling, the second layer is convolution+pooling, the third layer is convolution, the fourth layer is convolution, the fifth layer is convolution+pooling, the sixth layer is full connection, the seventh layer is full connection, and the eighth layer is full connection.

The CNN structure can be implemented by the dedicated circuit of the present invention. The first to fifth layers are sequentially implemented by the Convolution+Pooling module (convolution and pooling unit) in a time-sharing manner. The Controller module (control unit) controls a data input, a parameter configuration and an internal circuit connection of the Convolution+Pooling module. For example, when no pooling is required, the Controller module can control a data stream to directly skip the Pooling module. The sixth to eighth layers of the network are sequentially achieved by the Full Connection module of the invention in a time-sharing manner. The Controller module controls a data input, a parameter configuration, an internal circuit connection and so on of the Full Connection module.

### SPECIFIC IMPLEMENTATION EXAMPLE 2

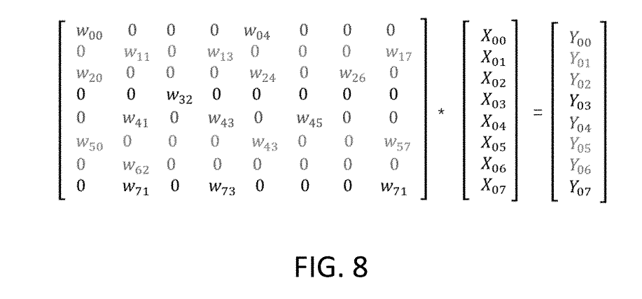

FIG. 8 is a schematic diagram illustrating a multiplication operation of a sparse matrix and a vector according to Specific Implementation Example 2 of the present invention.

With respect to the multiplication operation of the sparse matrix and the vector of the FC layer, four calculation units (process elements, PEs) calculate one matrix vector multiplication, and a column storage (CCS) is taken as an example to give detailed descriptions.

As shown in FIG. 8, the elements in the first and fifth rows are completed by PE0, the elements in the second and sixth rows are completed by PE1, the elements in the third and seventh rows are completed by PE2, the elements in the fourth and eight rows are completed by PE3, and the calculation results respectively correspond to the first and fifth elements, the second and sixth elements, the third and seventh elements, and the fourth and eighth elements of the output vector. The input vector will be broadcast to the four calculation units.

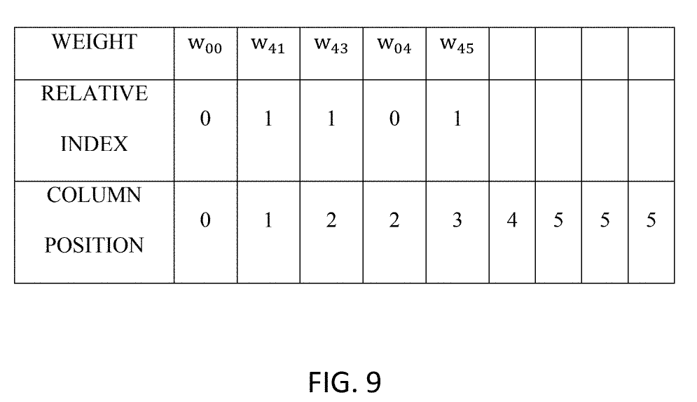

FIG. 9 is a schematic table illustrating weight information corresponding to PE0 according to Specific Implementation Example 2 of the present invention.

As shown in FIG. 9, the table shows the weight information corresponding to the PE0.

Functions in respective modules of the PE0 are introduced below.

A PtrRead module 0 (pointer) is used for storing column position information of nonzero elements in the first and fifth rows, wherein P(j+1)-P(j) is the number of the nonzero elements in the jth column.

An SpmatReard module is used for storing weight values and relative row indexes of the nonzero elements in the first and fifth rows.

An ActQueue module is used for storing an input vector X, the module broadcasting the input vector to the four calculation units PE0, PE1, PE2, PE3, where in order to balance the difference in terms of element sparsity between the calculation units, a first input first output buffer (FIFO) is added to an inlet of each of the calculation units to improve the calculation efficiency.

A Controller module is used for controlling a switch of a system state machine, achieving a calculation control, and synchronizing signals among the respective modules to thereby achieve multiplying the weight value by the element corresponding to the input vector and accumulating values in the corresponding row.

An ALU module is used for completing a multiplication-accumulation of elements in odd lines of the weight matrix and the corresponding element of the input vector X.

An ActBuffer module is used for storing the intermediate calculation result and the final first and fifth elements of y.

Similarly, another calculation unit PE1 calculates the second and sixth elements of y, and the other PEs perform the calculations in the same manner.

Various embodiments and implementations have been described above. But the spirit and scope of the invention are not limited to this. Those skilled in the art can make more applications according to the teaching of the invention, and these applications are all within the scope of the invention.

1. An apparatus for achieving an accelerator of a sparse convolutional neural network, comprising:
a convolution and pooling unit for performing a convolution and pooling operation, for a first iteration number of times, on input data in accordance with convolution parameter information to finally obtain an input vector of a sparse neural network, wherein each input data is divided into a plurality of sub-blocks, and the convolution and pooling unit performs the convolution and pooling operation on the plurality of sub-blocks in parallel;
a full connection unit for performing a full connection calculation, for a second iteration number of times, on the input vector in accordance with weight matrix position information of a fill connection layer to finally obtain a calculation result of the sparse convolutional neural network, wherein each input vector is divided into a plurality of sub-blocks, and the full connection unit performs a full connection operation on the plurality of sub-blocks in parallel; and
a control unit for determining and sending the convolution parameter information and the weight matrix position information of the full connection layer to the convolution and pooling unit and the full connection unit respectively, and controlling reading of the input vectors on respective iterative levels in the units above and their state machines.

2. The apparatus for achieving an accelerator of a sparse convolutional neural network according to claim 1, wherein the convolution and pooling unit further comprises:
a convolution unit for performing a multiplication operation of the input data and the convolution parameter;
an adder tree unit for accumulating output results of the convolution unit to complete a convolution operation;
a nonlinear unit for performing a nonlinear processing on a convolution operation result; and
a pooling unit for performing a pooling operation on the operation result after the nonlinear processing to obtain the input data on the next iterative level or finally obtain the input vector of the sparse neural network.

3. The apparatus for achieving an accelerator of a sparse convolutional neural network according to claim 1, wherein the full connection unit further comprises:
an input vector buffer unit for buffering the input vector of the sparse neural network;
a pointer information buffer unit for buffering compressed pointer information of the sparse neural network in accordance with the weight matrix position information of the full connection layer;
a weight information buffer unit for buffering compressed weight information of the sparse neural network in accordance with the compressed pointer information of the sparse neural network;
an arithmetic logic unit (ALU) for performing a multiplication-accumulation calculation in accordance with the compressed weight information and the input vector of the sparse neural network;
an output buffer unit for buffering an intermediate calculation result and a final calculation result of the ALU; and
an activation function unit for performing an activation function operation on the final calculation result in the output buffer unit to obtain the calculation result of the sparse convolutional neural network.

4. The apparatus for achieving an accelerator of a sparse convolutional neural network according to claim 2, wherein the adder tree unit further adds a bias in accordance with the convolution parameter information, in addition to accumulating output results of the convolution unit.

5. The apparatus for achieving an accelerator of a sparse convolutional neural network according to claim 3, wherein the compressed weight information of the sparse neural network comprises a position index value and a weight value, and
the ALU is further configured to:
perform a multiplication operation of the weight value and a corresponding element of the input vector,
read data in a corresponding position in the output buffer unit in accordance with the position index value, and add the data to the result of the multiplication operation above, and
write the result of the addition into the corresponding position in the output buffer unit in accordance with the position index value.

6. A method for achieving an accelerator of a sparse convolutional neural network, comprising:
reading convolution parameter information and input data and intermediate calculation data based on control information, and reading weight matrix position information of a full connection layer;
performing a convolution and pooling operation, for a first iteration number of times, on the input data in accordance with the convolution parameter information to finally obtain an input vector of a sparse neural network, wherein each input data is divided into a plurality of sub-blocks, and the convolution and pooling operation is performed on the plurality of sub-blocks in parallel; and
performing a full connection calculation, for a second iteration number of times, on the input vector in accordance with the weight matrix position information of the full connection layer to finally obtain a calculation result of the sparse convolutional neural network, wherein each input vector is divided into a plurality of sub-blocks, and a full connection operation is performed in parallel.

7. The method for achieving an accelerator of a sparse convolutional neural network according to claim 6, wherein the step of performing a convolution and pooling operation further comprises:
performing a multiplication operation of the input data and the convolution parameter;
accumulating output results of the multiplication operation to complete a convolution operation;
performing a nonlinear processing on a convolution operation result; and
performing a pooling operation on the operation result after the nonlinear processing to obtain the input data on the next iterative level or finally obtain the input vector of the sparse neural network.

8. The method for achieving an accelerator of a sparse convolutional neural network according to claim 6, wherein the step of performing a full connection calculation further comprises:
buffering the input vector of the sparse neural network;
buffering compressed pointer information of the sparse neural network in accordance with the weight matrix position information of the full connection layer;
buffering compressed weight information of the sparse neural network in accordance with the compressed pointer information of the sparse neural network;
performing a multiplication-accumulation calculation in accordance with the compressed weight information and the input vector of the sparse neural network;
buffering an intermediate calculation result and a final calculation result of the multiplication-accumulation calculation; and
performing an activation function operation on the final calculation result of the multiplication-accumulation calculation to obtain the calculation result of the sparse convolutional neural network.

9. The method for achieving an accelerator of a sparse convolutional neural network according to claim 7, wherein the step of accumulating output results of the multiplication operation to complete a convolution operation further comprises: adding a bias in accordance with the convolution parameter information.

10. The method for achieving an accelerator of a sparse convolutional neural network according to claim 8, wherein the compressed weight information of the sparse neural network comprises a position index value and a weight value, and
the step of performing a multiplication-accumulation calculation in accordance with the compressed weight information and the input vector of the sparse neural network further comprises:
performing a multiplication operation of the weight value and a corresponding element of the input vector,
reading data in a corresponding position in the buffered intermediate calculation result in accordance with the position index value, and adding the data to the result of the multiplication operation above, and
writing the result of the addition into the corresponding position in the buffered intermediate calculation result in accordance with the position index value.
